(19) United States
(12) Patent Application Publication
(10) Pub. No.: US 2004/0073568 A1
(43) Pub. Date: Apr. 15, 2004

(54) Image recording device, image recording system, image recording method, and storage medium for storing image recording program

(76) Inventor: Makoto Yonaha, Kanagawa (JP)

Correspondence Address: BIRCH STEWART KOLASCH & BIRCH, PO BOX 747, FALLS CHURCH, VA, 22040-0747, US

(21) Appl. No.: 10/671,500

(22) Filed: Sep. 29, 2003

(30) Foreign Application Priority Data
Sep. 30, 2002 (JP) 2002-287187

(51) Int. Cl. G06F 17/00

(52) U.S. Cl. 707/102

(57) ABSTRACT

An information recording device and an information recording system which can effectively use empty space of a recording medium, which empty space is formed after writing of image data. Advertisement information or positional information representing a position of the advertisement information is selected based on personal information of an orderer, photographing information representing a situation at the time of photographing, or the image data itself. The selected information is written onto empty space of a removable medium after the image data has been written thereon.

### CROSS-REFERENCE TO RELATED APPLICATION

This application claims priority under 35 USC 119 from Japanese Patent Application No. 2002-287187, the disclosure of which is incorporated by reference herein.

### BACKGROUND OF THE INVENTION

1. Field of the Invention

The present invention relates to an information recording device, an information recording system, an image recording method, and a storage medium for storing an image recording program, and more particularly to an information recording device and an information recording system which record on a recording medium image data obtained by photographing an object.

2. Description of the Related Art

In recent years, services for digitalizing images photographed on photographic silver films with cameras and writing the images onto disc-shaped recording media such as CD-Rs have been widely provided at laboratory shops, which are present at numerous locations and provide development services. Further, along with popularization of digital cameras, services for writing onto recording media image data obtained by photographing with digital cameras have been provided.

When an amount of image data written on a recording medium is small, empty space may be formed in the recording medium. In order not to waste the empty space, recording of additional image data, namely, providing so-called additional image data recording services, has been considered. However, when a scratch or the like is present on a recording medium that a customer has brought in, substantial time is spent without a writing process being performed normally, whereby productivity of a laboratory shop deteriorates. For this reason, many laboratory shops do not provide additional image data recording services.

A photograph print order system for reliably using a service provided by a laboratory shop has been known (for example, refer to Japanese Patent Application Laid-Open (JP-A) No. 10-214295). In this system, print service information representing a print service that can be provided by a laboratory shop is recorded on a recording medium together with data of a photographic image such that print order information corresponding to the service that can be provided by the laboratory shop can be easily generated in an electronic data format.

However, the above-mentioned conventional medium write service has a problem in that empty space of a recording medium generated after writing of image data is not effectively used when the additional image data recording service is not carried out.

The conventional medium write service also has a problem in that the service is too expensive to use freely.

Further, in the above-mentioned conventional photographic print order system, information recorded together with the photographic image data is limited to print service information. Therefore, empty space is not effectively used. Furthermore, no effective means for reducing a charge for the service has yet been provided.

### SUMMARY OF THE INVENTION

The present invention has been devised to solve the above-described problems. An object of the present invention is to provide an information recording device and an information recording system which can effectively use empty space of a recording medium, which empty space is formed after image data is written onto the recording medium.

In order to achieve the above object, a first aspect of the present invention is to provide an information recording device comprising: a selecting portion which selects at least one piece of advertisement information from multiple pieces of advertisement information or at least one piece of positional information from multiple pieces of positional information each representing a position at which the advertisement information is recorded, based on at least one of image data obtained by photographing an object, photographing information representing a situation in which the object was photographed, and personal information of an orderer who places an order for recording of the image data on a recording medium; and a recording portion which records the image data on the recording medium and records the selected information on empty space of the recording medium.

Namely, based on at least one of the image data obtained by photographing the object, the photographing information representing the situation in which the object was photographed, and the personal information of the orderer who places an order for recording of the image data on the recording medium, the selecting portion selects at least one piece of advertisement information from multiple pieces of advertisement information or at least one piece of positional information from multiple pieces of positional information each representing the position at which the advertisement information is recorded. Further, the recording portion records the image data on the recording medium and the information selected by the selecting portion on empty space of the recording medium.

The image data is not limited to image data of a still image but may be image data of a continuous image or a dynamic image.

When the advertisement information or the like is selected based on the image data, the selection may be based on the object (scene) included in the image. Namely, since the photographed object is an object which interests a person who photographed the image, appropriate advertisement information or positional information can be easily selected based on the photographed object. In this case, the advertisement information or the like may be selected by a computer system automatically analyzing the object from the photographed image or may be manually selected by an operator from the photographed image displayed on a display or the like.

The photographing information representing the situation in which the object was photographed, which information is used at the time of selecting the advertisement information or the like, may include at least one of area information representing the location of photographing and time information representing the date of photographing. When the area information is used, advertisement information on an area (such as advertisement information on specialty products of the area) can be selected. When the time information is used, information on a seasonal event (such as advertisement information on an entrance ceremony, a graduation ceremony, New Year's holidays, Christmas, or the like) can be selected.

The personal information of the orderer which is used to select the advertisement information or the like may include information by which social status or preferences of the orderer can be determined (such as age, sex, position in the workplace, or the like). With the personal information, the advertisement information suitable for each orderer can be selected.

As described above, since the advertisement information or the positional information representing the position at which the advertisement information is recorded can be selected and recorded on empty space of the recording medium having the image data recorded thereon, an advertiser can effectively provide advertisement information or positional information which is likely to be used. Namely, empty space of the recording medium can be effectively used. Further, a fee for writing the image data on the recording medium, which fee is charged to the orderer, can also be charged to an advertisement information provider, whereby the fee that the orderer must pay is reduced.

Further, when the positional information representing the position at which the advertisement information, such as information on a URL of an advertisement site accessible via the Internet, is recorded on the recording medium instead of the advertisement information itself, recording capacity is reduced, and the amount of time for a recording process can be decreased. In this case, since the advertisement information provider can easily change the content of the advertisement site, an effective advertisement effect can be obtained over a long period of time as compared with a case in which the advertisement information itself is written on the recording medium.

Furthermore, when the orderer places an order for the medium write service, at least one of the image data, the photographing information, and the personal information may be transmitted over the Internet together with order information. Alternatively, the orderer may directly bring in a recording medium having the image data recorded thereon to a service provider (such as a laboratory shop) and the service provider may enter the information.

A second aspect of the present invention is to provide an information recording system comprising: a transmission device for transmitting via a network image data obtained by photographing an object and order information for recording the image data onto a recording medium, the order information including personal information of an orderer; an advertisement database connected to the network, the advertisement database having recorded therein in advance multiple pieces of advertisement information or multiple pieces of positional information each representing a position where the advertisement information is recorded; and an information recording device connected to the network, the information recording device recording on the recording medium image data transmitted from the transmission device and recording selected information on empty space of the recording medium, wherein, in the information recording device or the advertisement database, the information to be recorded on the empty space is selected from at least one of the multiple pieces of advertisement information or the multiple pieces of positional information based on at least one of the image data transmitted from the transmission device via the network and the personal information.

Namely, in the information recording system, the transmission device transmits order information including the image data obtained by photographing the object and the order information for recording the image data onto the recording medium, which order information includes the personal information of the orderer. Multiple pieces of the advertisement information or multiple pieces of the positional information each representing a position where the advertisement information is recorded are recorded in the advertisement database in advance. The information recording device or the advertisement database selects at least one of the advertisement information and the positional information based on at least one of the image data transmitted from the transmission device and the personal information. The information recording device records on the recording medium the image data transmitted from the transmission device and records the selected information on the empty space of the recording medium.

With the above structure, empty space of the recording medium can be effectively used. Further, since the image data and the order information can be transmitted or received via the network, processing speed increases.

The network used to transmit and receive data may be a LAN or a WAN, or may be a network such as the Internet. Further, the order information may be transmitted via communication in which a PHS or a cell phone is used as the transmission device, or may be transmitted by using a terminal connected to the network and serving as the transmission device.

A third aspect of the present invention is to provide an information recording system comprising: a transmission device for transmitting via a network image data obtained by photographing an object, photographing information representing a situation in which the object was photographed, and order information for recording the image data onto a recording medium, the order information including personal information of an orderer; an advertisement database connected to the network, the advertisement database having recorded therein in advance multiple pieces of advertisement information or multiple pieces of positional information each representing a position where the advertisement information is recorded; and an information recording device connected to the network, the information recording device recording on the recording medium image data transmitted from the transmission device and recording selected information on empty space of the recording medium, wherein, in the information recording device or the advertisement database, the information to be recorded on the empty space is selected from at least one of the multiple pieces of advertisement information or the multiple pieces of positional information based on at least one of the image data transmitted from the transmission device via the network, the photographing information representing the situation in which the object was photographed, and the personal information.

Namely, in the information recording system, the transmission device transmits the photographing information representing the situation in which the object was photographed, in addition to the image data and the order information including the personal information of the orderer. The information recording device or the advertisement database selects at least one of the advertisement information and the positional information based on at least one of the image data transmitted from the transmission device, the personal information, and the photographing information.

With this structure, empty space of the recording medium can be effectively used. Further, since the image data and the order information can be transmitted or received via the network, processing speed increases. Furthermore, since the photographing information representing the situation in which the object was photographed is included in the information based on which the advertisement information or the positional information is selected, the advertisement information or the positional information which is likely to be used by the orderer can be selected and recorded.

Moreover, the information recording system further comprises a personal information database connected to the network and having recorded therein at least one of the personal information included in the order information and personal information that the orderer has registered in advance. When the advertisement information or the positional information is selected based on the personal information in the information recording device or in the advertisement database, the advertisement information or the positional information is selected based on the personal information provided from the personal information database.

With the above structure, when the information recording device or the advertisement database selects the advertisement information or the positional information based on the personal information, the personal information can easily be referred to.

The advertisement database or the personal information database may be included in the information recording device or separately installed as an external device.

Further, the information recording system may further comprise an advertisement information providing device which includes a recording medium having the advertisement information recorded thereon and provides to the advertisement database at least one of the advertisement information and the positional information representing a position where the advertisement information is recorded. The advertisement information providing device may be connected to the network, and the advertisement database may transmit charging information to the advertisement information providing device. The positional information may represent a position on the network where the advertisement information is recorded.

A fourth aspect of the present invention is to provide an information recording method comprising: selecting at least one of multiple pieces of advertisement information or at least one of multiple pieces of positional information based on at least one of image data obtained by photographing an object, photographing information representing a situation in which the object was photographed, and personal information of an orderer who places an order for recording of the image data on a recording medium; and recording the image data on the recording medium and recording the selected information on empty space of the recording medium.

The information recording method may further comprise recording the multiple pieces of advertisement information or the multiple pieces of positional information in the advertisement database in advance.

A fifth aspect of the present invention is to provide a storage medium which has stored thereon an information recording program for making a computer execute a predetermined process, the predetermined process comprising: selecting at least one of multiple pieces of advertisement information or at least one of multiple pieces of positional information based on at least one of image data obtained by photographing an object, photographing information representing a situation in which the object was photographed, and personal information of an orderer who places an order for recording of the image data on a recording medium; and recording the image data on the recording medium and recording the selected information on empty space of the recording medium.

### BRIEF DESCRIPTION OF THE DRAWINGS

FIG. 1 is a schematic view showing an overall structure of a medium write system according to an embodiment of the present invention having a computer network system incorporated therein.

FIG. 2 is a schematic view showing a functional structure and data flow of the medium write system according to the embodiment.

FIG. 3 is a flowchart of a process routine executed by a CPU of a net center server.

FIG. 4 is a flowchart of a process routine executed by a CPU of a laboratory server.

### DESCRIPTION OF THE PREFERRED EMBODIMENTS

An embodiment of the present invention will now be described in detail with reference to drawings.

A case in which the present invention is applied to a medium write system using a network will be described below.

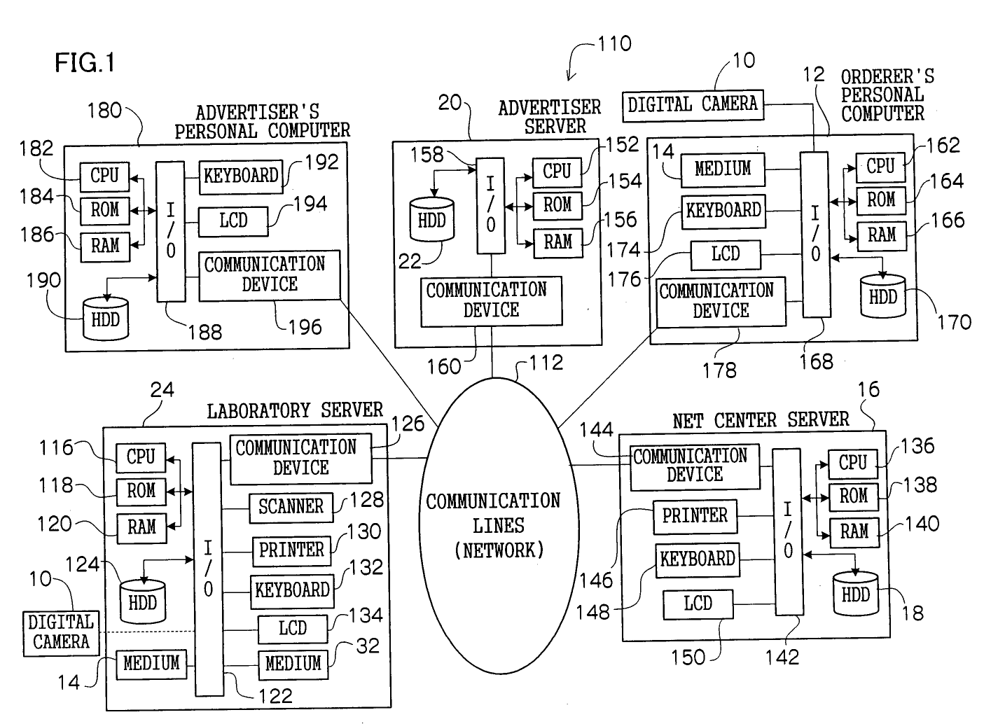

FIG. 1 is a schematic view showing an overall structure of a medium write system 110 according to an embodiment of the present invention having a computer network system incorporated therein. The medium write system 110 is structured such that various devices such as a laboratory server to be described later and the like are connected to communication lines 112 via connecting devices such as routers and terminal adapters. The communication lines 112 include a communication network such as the Internet.

A laboratory server 24, a net center server 16, an advertiser server 20, an advertiser's personal computer 180, and an orderer's personal computer 12 are connected to the communication lines 112 via the connecting devices. The laboratory server 24 is installed at a laboratory shop and serves to write image data ordered by an orderer, advertisement information, and the like onto a removable medium 32 such as a CD-R. The net center server 16 receives the image data and order information from the orderer and transmits necessary data to the laboratory server 24. The advertiser server 20 accumulates advertisement information or the like provided by advertisers, transmits the accumulated advertisement information or the like to the laboratory server 24, and transmits charging information to each advertiser. The advertiser's personal computer 180 accesses the advertiser server 20 to upload advertisement information or the like and receives charging information or the like from the advertiser server 20. The orderer's personal computer 12 generates order information for a medium write service and transmits the order information together with image data.

In this description, one computer is used for each of the devices such as the laboratory server 24, the orderer's personal computer, and the like. However, the number of computers used is not limited to one in the present invention, and a plurality of computers may be used for each device.

The laboratory server 24 includes a computer having a CPU 116, a ROM 118, and a RAM 120 and structured so as to transmit or receive data and commands to or from the CPU 116, the ROM 118, and the RAM 120 via an input/output interface (hereinafter referred to as “I/O”) 122. A hard disk drive (HDD) 124, a communication device 126, a scanner 128, a printer 130, a keyboard 132, and a liquid crystal display 134 are connected to the I/O 122.

A program of a routine for executing a process of writing image data provided by an orderer and advertisement information or the like onto the removable medium 32 such as a CD-R, and a list of advertisement types are stored in the ROM 118. In order to obtain advertisement information or the like from the advertiser server 20, an advertisement type is selected from the list and transmitted to the advertiser server 20. The program and the list of advertisement types may be stored in the HDD 124.

The communication device 126 mainly transmits and receives information to and from other computers. Further, the scanner 128 reads images from a photographic film or the like, and the printer 130 prints the images read by the scanner 128.

The removable medium 32 can be connected to the I/O 122 such that image data can be written on the removable medium 32 in response to an order from the orderer.

Moreover, a removable medium 14 such as SmartMedia, which is smaller than the removable medium 32 in its memory capacity and has images photographed with a digital camera 10 recorded thereon, can also be connected to the I/O 122. With this structure, it is possible to read image data recorded on the removable medium 14 which was directly brought in to a laboratory shop by the orderer.

The digital camera 10 can be connected to the I/O 122. When the digital camera 10 having image data recorded on internal memory thereof is directly brought in to the laboratory shop by the orderer, the image data can be read from the digital camera 10.

Personal information (such as name, address, telephone number, age, sex, and ID) of the orderer is stored in the HDD (i.e., personal information database) 18. The personal information is provided by the orderer and stored in advance. At that time, an ID for identifying each orderer is given to the orderer, and other information is stored in connection with the ID. The personal information is constantly managed by the CPU 136 and updated if there is any change made to the information. Further, a program of a routine for executing a process of receiving order information of the orderer together with image data and transferring the information and the image data to the laboratory server 24 is stored in the ROM 138. The program may be stored in the HDD 18 in a region different from a region in which the personal information is stored.

The advertiser server 20 includes a computer having a CPU 152, a ROM 154, and a RAM 156 and structured so as to transmit or receive data and commands to or from the CPU 152, the ROM 154, and the RAM 156 via an I/O 158. A HDD (i.e., advertisement database) 22 and a communication device 160 are connected to the I/O 158.

Positional information, which represents a position of advertisement information provided by the advertiser (i.e., URL information or the like for gaining access via a network to a site where the advertisement information is provided), is stored in the HDD 22 for each advertisement type. Further, a program of a routine for executing a process of transmitting the advertisement information or the positional information to the laboratory server 24, and a program of a routine for executing a process of transmitting to each advertiser charging information which has been received from the laboratory server 24 are stored in the ROM 154. The programs may be stored in the HDD 22 in a region different from a region in which the advertisement information or the positional information is stored.

The orderer's personal computer 12 includes a microcomputer having a CPU 162, a ROM 164, and a RAM 166 and structured so as to transmit or receive data and commands to or from the CPU 162, the ROM 164, and the RAM 166 via an I/O 168. A HDD 170, a communication device 178, a keyboard 174, and a liquid crystal display 176 are connected to the I/O 168.

The removable medium 14 can be connected to the I/O 168 such that data recorded on the removable medium 14 can be read. Moreover, the digital camera 10 can also be connected to the I/O 168 such that data recorded in internal memory of the digital camera 10 can be read.

The advertiser's personal computer 180 includes a microcomputer having a CPU 182, a ROM 184, and a RAM 186 and structured so as to transmit or receive data and commands to or from the CPU 182, the ROM 184, and the RAM 186 via an I/O 188. A HDD 190, a communication device 196, a keyboard 192, and a liquid crystal display 194 are connected to the I/O 188.

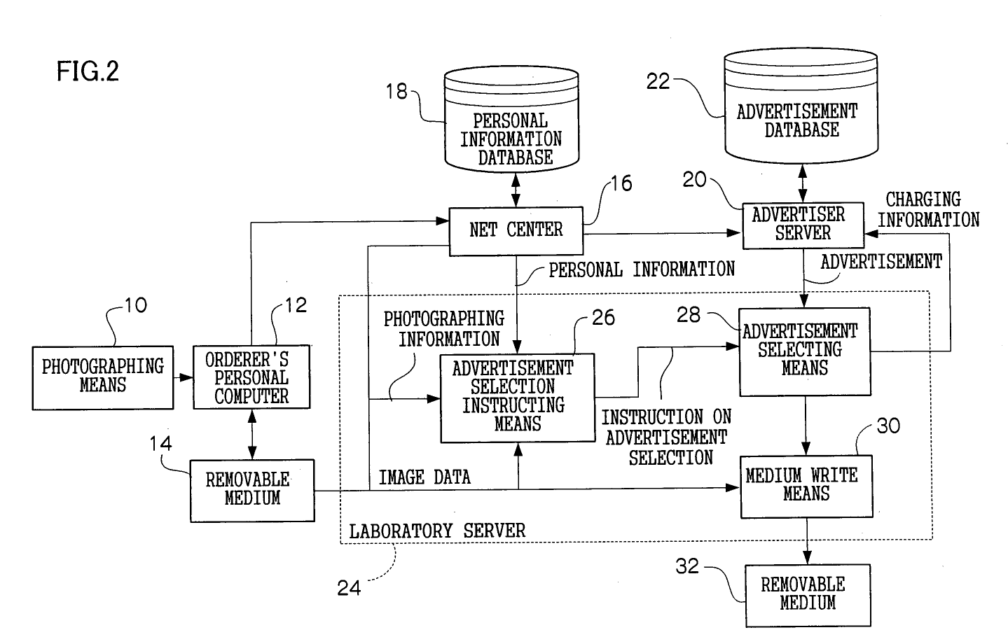

FIG. 2 is a schematic view showing a functional structure and data flow of the medium write system 110 described above.

First, in order to use the medium write service at a laboratory shop, the orderer transmits photographing information (such as a location and a date of photographing), which represents image data of an image (which may be a still image, a continuous image, or a dynamic image) photographed with a photographing device (such as a digital camera) 10 and a situation in which an object was photographed, to the laboratory shop via a network, together with order information for a service by which image data is written onto the removable medium 32 such as a CD-R. Specifically, the photographing information is read from the digital camera 10 or the removable medium 14 and transmitted from the orderer's personal computer 12 to the net center server 16 and then to the laboratory shop via the communication lines (i.e., the network) such as the Internet. The image data may be stored on the removable medium 14 such as the SmartMedia, which may be directly brought in to the laboratory shop.

The image data and the order information transmitted or brought in are inputted to the laboratory shop's server (i.e., laboratory server) 24. Further, personal information of the orderer is inputted from the personal information database 18 via the net cetner server 16 to the laboratory server 24. The image data and the photographing information are separately analyzed by an advertisement selection instructing device 26 of the laboratory server 24. The personal information of the orderer is also analyzed, and an advertisement type of advertisement information to be written onto the removable medium 32 is selected from among predetermined advertisement types.

Once an advertisement type is selected by the advertisement selection instructing device 26 of the laboratory server 24, an instruction on the selection of an advertisement of the selected advertisement type is transmitted to an advertisement selecting device 28 of the laboratory server 24. The advertisement selecting device 28 follows the instruction by obtaining advertisement information or positional information from the advertisement database 22 via the advertiser server 20 and transmits the information to a medium write device 30 of the laboratory server 24. The medium write device 30 writes the image data having the photographing information added thereto onto the removable medium 32 and also writes the advertisement information or the positional information onto empty space of the removable medium 32. Moreover, the advertisement selecting device 28 transmits to the advertiser server 20 charging information on a fee required to write the advertisement information or the positional information such that a part or all of the fee that the orderer must pay for the write service is paid by the advertiser.

The data flow in the medium write system according to the present embodiment has been schematically described above. Next, a process routine executed by each server in the medium write system 110 according to the present embodiment will be described below in more detail.

First, the digital camera 10 is connected to the orderer's personal computer 12 by the orderer. The image data obtained by photographing an object and the photographing information representing a situation in which the object was photographed are stored in the internal memory of the digital camera 10. Once the digital camera 10 is connected to the orderer's personal computer 12, the image data and the photographing information stored in the internal memory are read by the CPU 162, temporarily stored in the RAM 166, and then stored in the HDD 170. When the image data and the photographing information are stored not in the internal memory of the digital camera 10 but on the removable medium 14 such as the SmartMedia, the image data and the photographing information are read by loading the removable medium 14 into the orderer's personal computer 12.

Further, the orderer prepares order information on the orderer's personal computer 12 and transmits the information to the net center server 16, together with the image data and the photographing information stored in the HDD 170. The order information includes an ID for identifying the orderer, information on a change in the personal information if any, the type and number of the removable medium/media on which the image data is written, information specifying, from among a series of image data, the image data (of a photographic frame) to be written onto the removable medium 32, and the address to which the removable medium 32 is delivered after the writing process.

The image data transmitted from the orderer may have a format (such as the Exif format) in which the photographing information is recorded together with the image data itself and can be processed as a part of the image data.

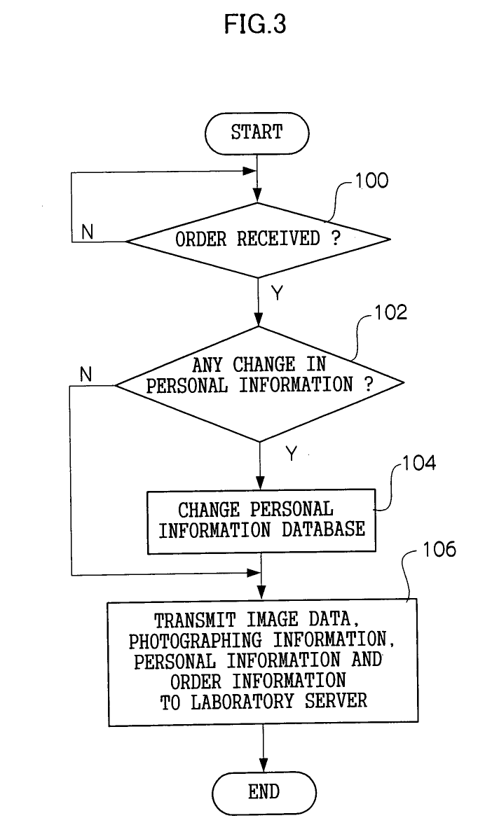

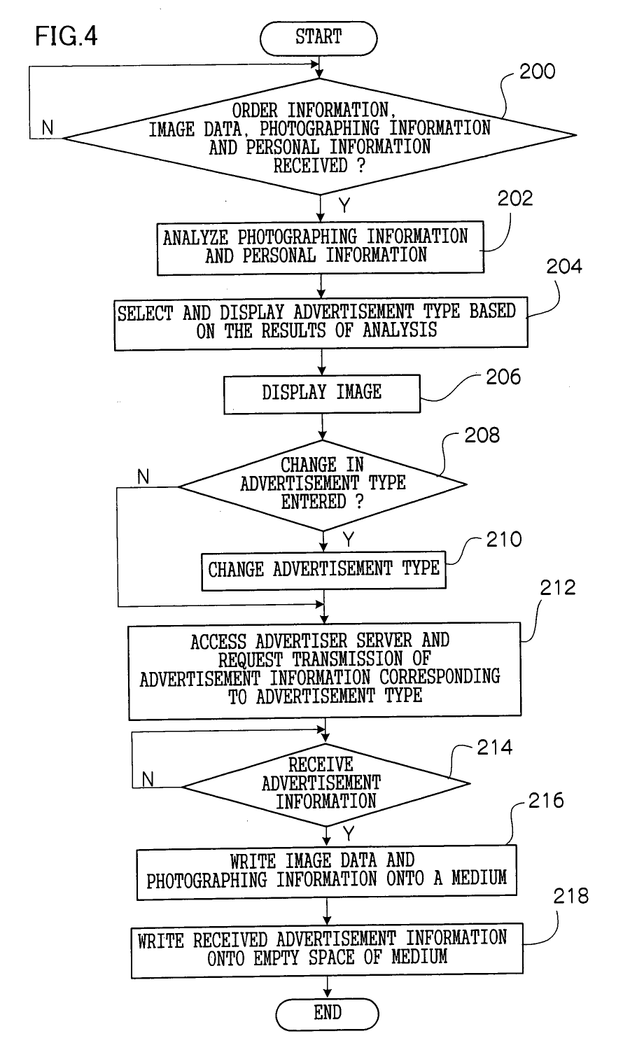

Next, processes executed on the side of the medium write service provider will be described with reference to FIGS. 3 and 4.

FIG. 3 shows a process routine executed by the CPU 136 of the net center server 16. First, in step 100, a determination is made as to whether order information has been received from the orderer's personal computer 12 together with image data and photographing information. When the determination is affirmative, in step 102, a determination is made as to whether the order information includes information on a change in the personal information of the orderer. When the determination is affirmative, in step 104, the content of the personal information database 18, namely, the personal information corresponding to the ID included in the order information, is updated based on the information on the change. When the determination is negative, the processing in step 104 is not carried out, and the routine proceeds to step 106. In step 106, the personal information of the orderer corresponding to the ID included in the order information is read from the personal information database 18 and transmitted to the laboratory server 24 together with the image data, the photographing information, and the order information which have been received from the orderer's personal computer 12.

A process executed by the laboratory server 24 will be described next.

FIG. 4 shows a process routine executed by the CPU 116 of the laboratory server 24.

In step 200, a determination is made as to whether the order information, the image data, the photographing information, and the personal information of the orderer have been received. When the determination is affirmative, the photographing information and the personal information of the orderer are analyzed in step 202. In step 204, based on the results of the analysis in step 202, an advertisement type of an advertisement to be written on empty space of the removable medium 32 after the image data has been written thereon is selected from the advertisement types stored in the ROM 118, and the result of the selection is displayed on the liquid crystal display 134.

For example, an advertisement type relating to the area where a person photographed the image can be selected using information on the location of photographing. Specifically, an advertisement relating to specialty products sold in an area around the location of photographing, an advertisement relating to sightseeing of the area around the location of photographing, or the like can be selected.

Information on the longitude and the latitude of the location of photographing may be automatically obtained by a GPS (Global Positioning System) included in the digital camera 10 and may be recorded as the photographing information on the removable medium 14 or the like, together with the image data. Alternatively, information specifying the location of photographing may be manually inputted by the person who photographed the image via input means of the digital camera 10.

Further, by using information on the date of photographing, an advertisement type can be selected based on the time when the image was photographed. For example, an advertisement relating to an event which will take place after the date of photographing (e.g., advertisement of New Year's holidays, St. Valentine's Day, or the like when the image was photographed on Christmas), an advertisement relating to an event taking place at and around the time when the image was photographed (e.g., an advertisement relating to summer, winter, or spring holidays when the date of photographing is during summer, winter, or spring holidays), or the like can be selected.

Furthermore, an advertisement type which may interest the orderer can be selected by using the personal information of the orderer. For example, when the orderer is an elderly person, an advertisement relating to welfare services can be selected. When the orderer is female, an advertisement relating to sales at a department store or the like can be selected.

One advertisement type or a plurality of advertisement types may be selected. For example, when one advertisement type is selected, priorities may be set for the information based on which an advertisement type is selected (such as the date of photographing, the location of photographing, age, and sex). Whether an advertisement type corresponding to each priority level is present or not is checked in the order of descending priorities, and, when a corresponding advertisement type is present, the advertisement type is selected. When a plurality of advertisement types are selected, all of the advertisement types that can be selected may be selected. Alternatively, when the number of advertisement types to be selected is limited, advertisement types may be selected in the order of descending priorities until the number of the advertisement types reaches the limited number.

One advertisement type may be selected based on multiple pieces of information. For example, when the date of photographing is during New Year's holidays and the person who photographed the image is female, an advertisement relating to St. Valentine's Day is selected. In this way, advertisement types to be selected are narrowed down. With this technique, advertisement information or positional information which is likely to be used by the orderer can be written.

The advertisement type selected after the above analysis is displayed on the liquid crystal display 134. In this way, an operator at the laboratory shop can check the displayed advertisement type.

Next, in step 206, an image represented by the image data is displayed on the liquid crystal display 134. A change entry display is also displayed together with the image. The operator identifies an object from the image and enters information on a change of the advertisement type on the change entry display when he/she determines from the results of the identification that the selected advertisement type needs to be changed. The list of advertisement types is displayed on the change entry display so that the operator can freely select an advertisement type from the list.

Specifically, the operator can observe the content of photographing (i.e., the content of the image represented by the image data) and select an advertisement type which may interest the person who photographed the image. For example, when the object is a child, an advertisement on education or the like can be selected. When the operator determines that the advertisement type should be added to the advertisement type which has been selected based on the photographing information and the personal information of the orderer or should be used instead of the selected advertisement type, the operator can enter the change on the change entry display.

In step 208, a determination is made as to whether the information on a change of the advertisement type has been entered by the operator. When the determination is affirmative, in step 210, the advertisement type is changed according to the entered information. When the determination is negative, the processing in step 210 is not carried out, and the routine proceeds to step 212.

In step 212, the CPU 116 accesses the advertiser server 20 by transmitting the selected advertisement type and requests the advertiser server 20 to transmit the advertisement information corresponding to the advertisement type or the positional information representing the position of the advertisement information provided by the advertiser. When the request of the advertisement information or the positional information is received by the advertiser server 20, the corresponding advertisement information or positional information is extracted by the CPU 152 from the advertisement database 22 based on the received advertisement type and transmitted to the laboratory server 24.

In step 214, a determination is made as to whether the advertisement information or the positional information has been received from the advertiser server 20. When the determination is affirmative, in step 216, the image data and the photographing information are written onto the removable medium 32 loaded in the laboratory server 24 in advance, in accordance with the order information of the orderer. Thereafter, in step 218, the advertisement information or the positional information received from the advertiser server 20 is written onto empty space of the removable medium 32.

In addition to the advertisement information itself, the positional information representing the position where the advertisement information is recorded (i.e., URL information for gaining access via a network to a site where the advertisement information is provided) can be written onto the empty space. In this way, the amount of data to be written can be greatly reduced, and productivity of the writing process carried out on the removable medium 32 can be increased. When the advertisement information itself is written onto the removable medium 32, the content cannot be changed once the information is written. However, the content can be easily changed by providing the advertisement information to the site to be accessed. In this way, a good advertising effect can be obtained over a long period of time.

As a method for recording the advertisement information or the positional information, the advertisement information or the positional information may be collectively written after the image data and the photographing information have been collectively written, or the image data may be written first and then the advertisement information or the positional information corresponding to the image data may be written. The advertisement information and the positional information may be written together on the empty space, or only the advertisement information or the positional information may be written thereon.

The removable medium 32 which has been subjected to the writing process is delivered to an address specified in the order information.

In the laboratory server 24, a charging process for charging the advertiser a fee for writing the advertisement information is also executed. Specifically, after the advertisement information or the positional information has been obtained or written onto the removable medium 32, charging information for the advertiser is calculated based on the amount of data on the obtained (or written) advertisement information or positional information, and the calculated charging information is transmitted to the advertiser server 20. The charging information transmitted is transferred to the advertiser's personal computer 180 which has provided the advertisement information or positional information.

As described above, the advertisement information or the positional information is selected based on at least one of the personal information of the orderer, the photographing information representing the situation at the time of photographing, and the content of the image data, and the selected advertisement information or positional information is written onto empty space of the removable medium 32 after the image data has been written thereon. In this way, empty space which has not been conventionally used can be effectively used. Further, the advertiser can effectively provide advertisement information or positional information which is likely to be used.

Furthermore, since a fee for writing the advertisement information or positional information onto the removable medium 32 can be collected from the advertiser, service charge to be paid by the orderer can be reduced or eliminated.

In the above-described embodiment, a case has been described in which both the advertisement information and the positional information representing the position of the advertisement information are recorded in the advertisement database 22 of the advertiser server 20. However, the advertisement database 22 may be structured so as to record only the advertisement information or the positional information.

Moreover, in the above-described embodiment, a case has been described in which the advertisement information or the positional information is accumulated in the advertisement database 22 of the advertiser server 20. However, the advertisement information or the positional information may be accumulated in the advertiser's personal computer 180 of each advertiser, the laboratory server 24, or the net center server 16. Further, in the above embodiment, a case has been described in which the personal information is accumulated in the personal information database 18 of the net center server 16. However, the personal information may be accumulated in the laboratory server 24.

Furthermore, in the above-described embodiment, a case has been described in which the object (scene) is identified by the operator observing the photographed image which is displayed on the display, such that an advertisement type is selected manually by the operator. However, an advertisement type may be selected by a computer system automatically analyzing the object included in the photographed image.

In the above-described embodiment, a case has been described in which the advertisement type is selected by analyzing information in the laboratory server 24. However, the advertisement type may also be selected by transmitting various pieces of information from the laboratory server 24 to the advertiser server 20 and analyzing the information in the advertisement server 20.

Further, in the above embodiment, a case has been described in which charging information is calculated based on the amount of data of the written advertisement information or positional information. However, charging information may be calculated based on the number of pieces of the written advertisement information or positional information. Alternatively, a uniform fee may be collected from the advertiser.

Moreover, the present invention is not limited to the computer or the medium write system in the above-described embodiment and can be applied to various information recording devices and information recording systems.

As described above, according to the present invention, at least one of the advertisement information and the positional information representing the position of the advertisement information is selected based on at least one of the personal information of the orderer, the photographing information representing the situation of photographing, and the content of the image data, and the selected information is written onto empty space of the recording medium, which empty space is formed after the image data has been written onto the recording medium. Accordingly, the present invention has an excellent effect in that empty space of the recording medium can be effectively used.

What is claimed is:

1. An information recording device comprising:
a selecting portion which selects at least one piece of advertisement information from multiple pieces of advertisement information or at least one piece of positional information from multiple pieces of positional information each representing a position at which the advertisement information is recorded, based on at least one of image data obtained by photographing an object, photographing information representing a situation in which the object was photographed, and personal information of an orderer who places an order for recording of the image data on a recording medium; and
a recording portion which records the image data on the recording medium and records the selected information on empty space of the recording medium.

2. The information recording device of claim 1, wherein the photographing information includes at least one of a location and a date of photographing.

3. The information recording device of claim 1, wherein the advertisement information or the positional information is selected based on the object included in the image data.

4. The information recording device of claim 1, wherein the positional information represents a position on a network at which the advertisement information is recorded.

5. An information recording system comprising:
a transmission device for transmitting via a network image data obtained by photographing an object and order information for recording the image data onto a recording medium, the order information including personal information of an orderer;
an advertisement database connected to the network, the advertisement database having recorded therein in advance multiple pieces of advertisement information or multiple pieces of positional information each representing a position where the advertisement information is recorded; and
an information recording device connected to the network, the information recording device recording on the recording medium image data transmitted from the transmission device and recording selected information on empty space of the recording medium,
wherein, in the information recording device or the advertisement database, the information to be recorded on the empty space is selected from at least one of the multiple pieces of advertisement information or the multiple pieces of positional information based on at least one of the image data transmitted from the transmission device via the network and the personal information.

6. The information recording system of claim 5, further comprising an advertisement information providing device which includes a recording medium having the advertisement information recorded thereon and provides to the advertisement database at least one of the advertisement information and the positional information representing the position where the advertisement information is recorded.

7. The information recording system of claim 6, wherein the advertisement information providing device is connected to the network, and the advertisement database transmits charging information to the advertisement information providing device.

8. The information recording system of claim 5, wherein the positional information represents a position on the network where the advertisement information is recorded.

9. An information recording system comprising:
a transmission device for transmitting via a network image data obtained by photographing an object, photographing information representing a situation in which the object was photographed, and order information for recording the image data onto a recording medium, the order information including personal information of an orderer;
an advertisement database connected to the network, the advertisement database having recorded therein in advance multiple pieces of advertisement information or multiple pieces of positional information each representing a position where the advertisement information is recorded; and
an information recording device connected to the network, the information recording device recording on the recording medium image data transmitted from the transmission device and recording selected information on empty space of the recording medium,
wherein, in the information recording device or the advertisement database, the information to be recorded on the empty space is selected from at least one of the multiple pieces of advertisement information or the multiple pieces of positional information based on at least one of the image data transmitted from the transmission device via the network, the photographing information representing the situation in which the object was photographed, and the personal information.

10. The information recording system of claim 9, further comprising a personal information database connected to the network and having recorded therein at least one of the personal information included in the order information and personal information that the orderer has registered in advance,
wherein, when the advertisement information or the positional information is selected based on the personal information in the information recording device or in the advertisement database, the advertisement information or the positional information is selected based on the personal information provided from the personal information database.

11. The information recording system of claim 9, further comprising an advertisement information providing device which includes a recording medium having the advertisement information recorded thereon and provides to the advertisement database at least one of the advertisement information and the positional information representing a position where the advertisement information is recorded.

12. The information recording system of claim 11, wherein the advertisement information providing device is connected to the network, and the advertisement database transmits charging information to the advertisement information providing device.

13. The information recording system of claim 9, wherein the positional information represents a position on the network where the advertisement information is recorded.

14. An image recording method comprising:
selecting at least one of multiple pieces of advertisement information or at least one of multiple pieces of positional information each representing a position at which the advertisement information is recorded based on at least one of image data obtained by photographing an object, photographing information representing a situation in which the object was photographed, and personal information of an orderer who places an order for recording of the image data on a recording medium; and
recording the image data on the recording medium and recording the selected information on empty space of the recording medium.

15. The information recording method of claim 14, further comprising recording the multiple pieces of advertisement information or the multiple pieces of positional information in the advertisement database in advance.

16. A storage medium which has stored thereon an information recording program for making a computer execute a predetermined process, the predetermined process comprising:
selecting at least one of multiple pieces of advertisement information or at least one of multiple pieces of positional information based on at least one of image data obtained by photographing an object, photographing information representing a situation in which the object was photographed, and personal information of an orderer who places an order for recording of the image data on a recording medium; and
recording the image data on the recording medium and recording the selected information on empty space of the recording medium.
